(19) United States
(12) Patent Application Publication
(10) Pub. No.: US 2020/0341566 A1
(43) Pub. Date: Oct. 29, 2020

(54) MAGNETIC PEN TIP ASSEMBLY AND TABLET SYSTEM USING THE SAME

(71) Applicant: WALTOP INTERNATIONAL CORP., Hsinchu City (TW)

(72) Inventor: HSIN CHIANG HO, HSINCHU CITY (TW)

(21) Appl. No.: 16/521,886

(22) Filed: Jul. 25, 2019

(30) Foreign Application Priority Data
Apr. 23, 2019 (TW) 108205018
May 10, 2019 (TW) 108205809

(51) Int. Cl. G06F 3/0354; G06F 3/044; G06F 3/046

(52) U.S. Cl. CPC G06F 3/03545; G06F 3/046; G06F 3/0442

(57) ABSTRACT

The magnetic pen tip assembly includes a shielding component and a magnetic component, wherein the shielding component includes an opening and accommodating space, and the magnetic component is disposed in the accommodating space and includes a first end being exposed by the opening. The magnetic leakage of the magnetic component is thereby reduced since the magnetic component is surrounded and covered by the shielding component. The magnetic pen tip assembly is further implemented in a tablet system. When the user writes and draws on a magnetic drawing board with the magnetic pen tip assembly, the undesired drawing of magnetic particles in the magnetic drawing board due to magnetic leakage of the magnetic component is avoided. Therefore, issues such as blurred lines or early-responding, which are encountered by drawing on magnetic drawing boards with a conventional magnetic pen, can be effectively improved. Moreover, the magnetic pen tip assembly also serves as a stylus pen for a capacitance touch panel.

### REFERENCE TO RELATED APPLICATIONS

This non-provisional application claims priority claim under 35 U.S.C. § 119(a) on Taiwan Patent Application No. 108205018 filed Apr. 23, 2019 and Taiwan Patent Application No. 108205809 filed May 10, 2019 the entire contents of which are incorporated herein by reference.

### FIELD OF THE INVENTION

The invention relates to a magnetic pen tip assembly, more particularly, to a magnetic pen tip assembly using a shielding component to reduce magnetic leakage of a magnetic component in the magnetic pen tip assembly.

### BACKGROUND

A magnetic drawing board with a magnetic pen is not only a drawing toy for kids, but also a teaching tool. User can rewrite and redraw on the magnetic drawing board over and over by using the magnetic pen without polluting the environment with garbage such as paper, and unlike the volatile organic solvent in whiteboard pen or the calcium sulfate from chalk, no chemical substance toxic to human is released by the magnetic pen. Therefore, magnetic drawing board in combination with magnetic pen is a writing and drawing tool that is environmentally friendly and convenient to use.

The magnetic drawing board is usually composed of a layer of substrate and a layer of translucent or semi-translucent that is laid on top, and the middle layer between the substrate and the cover is filled with white thick liquid containing magnetic particles. When a magnetic substance, like a magnet or a magnetic component at the front tip of a magnetic pen, touches the cover of the magnetic drawing board, the magnetic particles are drawn to the surface of the cover and dark lines are visible on the surface. If the user wishes to erase what was on the magnetic drawing board, simply move a slider, which comes with the magnetic writing board and contains a magnet bar, across the magnetic writing board on the underside, and thus the magnetic particles are dragged downward and the visible lines disappear from the surface of the cover.

However, early-responding and blurred lines are two issues that are often encountered by users with the current magnetic drawing boards on the market. Early-responding is the early appearance of dark lines before the magnetic pen actually touches the cover surface. Blurred lines refer to the dark lines drawn on the cover surface that are not crisp on the edges. Both issues relate to the magnetic leakage of a magnetic component in the magnetic pen, wherein the magnetic particles in the magnetic drawing board are drawn by the magnetic field created by magnetic flux that detoured away from its desired path in the magnetic component at the front tip of the magnetic pen.

### SUMMARY

An object of the invention is to solve the aforementioned issue in the conventional magnetic pen and thus a magnetic pen tip assembly structured to reduce magnetic leakage is provided. The magnetic pen tip assembly uses a shielding component to cover around a magnetic component, wherein when the magnetic pen tip is used to draw a tablet, only a first end of the magnetic component is exposed by an opening of the shielding component to touch a magnetic drawing board. Moreover, the magnetic pen tip assembly can be used as a magnetic pen or a stylus pen for use in the tablet, such as a magnetic drawing board or a capacitance touch panel.

It is an object of the invention to provide a magnetic pen tip assembly. The magnetic pen tip assembly includes a shielding component and a magnetic component. The shielding component includes a first end, an opening and an accommodating space for accommodating the magnetic component. The magnetic component is disposed in the accommodating space and includes a first end. The magnetic component is surrounded and covered by the shielding component. The first end of the magnetic component is exposed by the opening of the shielding component, and a distance between the first end of the magnetic component and the first end of the shielding component is less than 2 millimeters.

Optionally, the distance is less than 0.05 millimeter.

Optionally, the magnetic component is a permanent magnet, a temporary magnet, an electromagnet, or an electric permanent magnet.

Optionally, the shielding component is made of a magnetically conductive metal or a plastic material.

Optionally, the shielding component is a turned part formed by turning processing a magnetically conductive material or a magnetically insulating material, or is a curled part formed by curling a sheet of a magnetically conductive material or a magnetically insulating material.

Optionally, the magnetic pen tip assembly is a magnetic pen for a magnetic drawing board or a stylus pen for a capacitance touch panel and further includes a barrel component that is connected to or accommodates the shielding component.

Optionally, the barrel component includes a tube portion and a tapered portion. The tube portion includes a first end and the tapered portion includes a first end and a second end opposite the first end. The first end of the tube portion is connected to the first end of the tapered portion and the tapered portion is tapered from its first end to its second end. The tapered portion further includes a space in which the shielding component is inserted or engaged, or alternatively, the shielding component is bonded to the second end of the tapered portion.

Optionally, the magnetic pen tip assembly is a magnetic pen refill of a magnetic pen for a magnetic drawing board or of a stylus pen for a capacitance touch panel and further includes a refill body that is connected to or accommodates the shielding component. A barrel component of the magnetic pen accommodates the magnetic tip assembly and an opening of the barrel component corresponds to the first end of the magnetic component.

Optionally, the refill body includes a first component and a second component. The second component is connected to or accommodates the first component. The first component includes a tube portion with a first end and a tapered portion with a first end and a second end opposite to the first end. The first end of the tube portion is connected to the first end of the tapered portion and the tapered portion is tapered from its first end to its second end. The tapered portion includes a space in which the shielding component is inserted or engaged, or alternatively, the shielding component is bonded to the second end of the tapered portion.

Optionally, the magnetic pen tip assembly is a magnetic pen for a magnetic drawing board or a stylus pen for a capacitance touch panel and further includes a refill body and a barrel component with an opening. The refill body is connected to or accommodates the shielding component, wherein the refill body, the shielding component, and the magnetic component form a magnetic pen refill. The barrel component accommodates the magnetic pen refill and the opening of the barrel component corresponds to the first end of the magnetic component.

Optionally, the barrel component includes a first component and a second component, wherein the opening of the barrel component is on the first component and the first component is detachably connected to the second component.

Optionally, the magnetic pen tip assembly further includes a plurality of refill switch components, at least one other magnetic pen refill, and a plurality of switch control components. The plurality of refill switch components are disposed in the barrel component and each of the plurality of magnetic pen refills is correspondingly connected to one of the plurality of refill switch components. The plurality of switch control components are disposed on the barrel component and control the plurality of refill switch components to switch the plurality of magnetic pen refills.

Optionally, the magnetic pen tip assembly is detachably disposed on a holder that is connected to a pen body.

It is another object of the invention to provide a tablet system. The tablet system includes a tablet and a magnetic pen (or a stylus pen), wherein the tablet is a magnetic drawing board or a capacitance touch panel, and the magnetic pen is any of the aforementioned magnetic pen (or any one of the aforementioned stylus pen).

The magnetic pen tip assembly provided by the invention resolves the early-responding and the blurred-line issues encountered by conventional magnetic pens. And, besides being used on a magnetic drawing board, the magnetic pen tip assembly is also usable as a stylus pen on a capacitance touch panel.

### BRIEF DESCRIPTION OF THE DRAWINGS

The structure as well as preferred modes of use, further objects, and advantages of this invention will be best understood by referring to the following detailed description of some illustrative embodiments in conjunction with the accompanying drawings, in which:

FIGS. 1A and 1B are respectively a schematic diagram and a sectional view of a magnetic pen tip assembly according to a first embodiment of the invention.

FIGS. 2A and 2B are respectively a schematic diagram and a sectional view of a magnetic pen tip assembly according to a second embodiment of the invention.

FIG. 3 is a sectional view of a magnetic pen tip assembly according to a third embodiment of the invention.

FIG. 4 is a sectional view of a magnetic pen tip assembly according to a fourth embodiment of the invention.

FIG. 5 is a sectional view of a magnetic pen tip assembly according to a fifth embodiment of the invention.

FIG. 6 is a sectional view of a magnetic pen tip assembly according to a sixth embodiment of the invention.

FIGS. 7A and 7B are respectively a schematic diagram and a sectional view of a magnetic pen tip assembly according to a seventh embodiment of the invention.

FIGS. 8A and 8B are respectively a schematic diagram and a sectional view of a magnetic pen tip assembly according to an eighth embodiment of the invention.

FIG. 9 is an exploded view of a magnetic pen tip assembly according to a ninth embodiment of the invention.

FIG. 10 is an exploded view of a magnetic pen tip assembly according to a tenth embodiment of the invention.

FIGS. 11A and 11B are respectively a schematic diagram and a sectional view of a magnetic writing board system according to an eleventh embodiment of the invention.

FIGS. 12A and 12B are respectively a schematic diagram and a sectional view of a changeable magnetic pen tip assembly according to a twelfth embodiment of the invention.

FIG. 12C is a schematic diagram illustrating a holder according to the twelfth embodiment of the invention.

### DETAILED DESCRIPTION OF THE PREFERRED EMBODIMENTS

According to embodiments of the invention, a magnetic pen tip assembly which resolves the magnetic leakage issue in conventional magnetic pens is provided, and hence issues evolved from magnetic leakage, such as blurred lines while writing or drawing on a magnetic drawing board with conventional magnetic pen, or early-responding of magnetic particles in the magnetic drawing board which leads to pattern appearance before the conventional magnetic pen touches the surface of the magnetic drawing board, are also avoided. In addition, the invention uses a shielding component to cover around a magnetic component and only a first end of the magnetic component is exposed, thereby further improving the magnetic leakage phenomenon. The shielding component is formed by a magnetically conductive material or a magnetically insulating material.

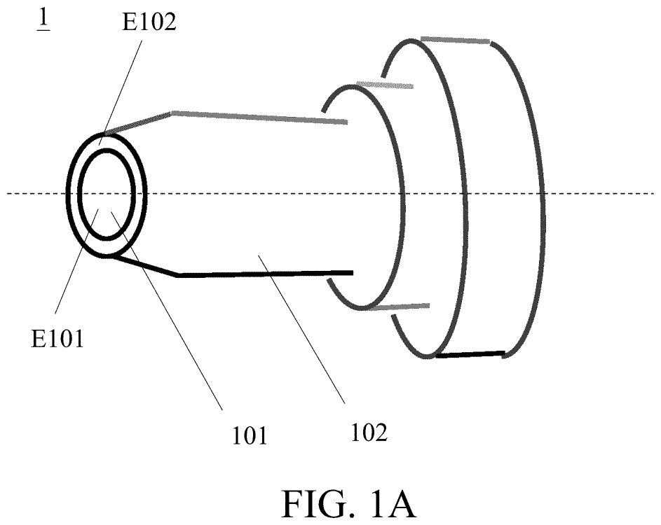

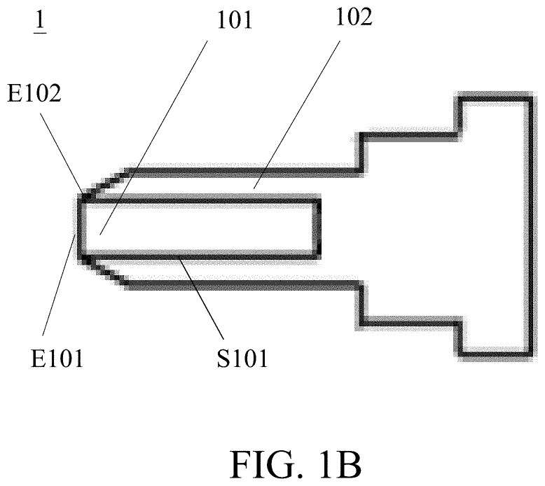

FIGS. 1A and 1B are respectively a schematic diagram and a sectional view of a magnetic pen tip assembly according to a first embodiment of the invention, wherein the dotted line in FIG. 1A is the sectional line. The magnetic pen tip assembly 1 includes a magnetic component 101 and a shielding component 102. The shielding component 102 includes an opening and an accommodating space S101 for accommodating the magnetic component 101. The magnetic component 101 is disposed in the accommodating space S101 and is surrounded and covered by the shielding component 102. A first end E101 of the magnetic component 101 is exposed by the opening of the shielding component 102 and is approximately aligned to a first end E102 of the shielding component 102.

In the first embodiment, the magnetic component 101 is a permanent magnet, a temporary magnet, an electromagnet, or an electric permanent magnet. The shielding component 102 is a turned part formed by turning processing a magnetically conductive material or a magnetically insulating material, such as a magnetically conductive metal or a plastic material. It is to be noted that the invention is not limited by the types of magnetic component 101 and shielding component 102.

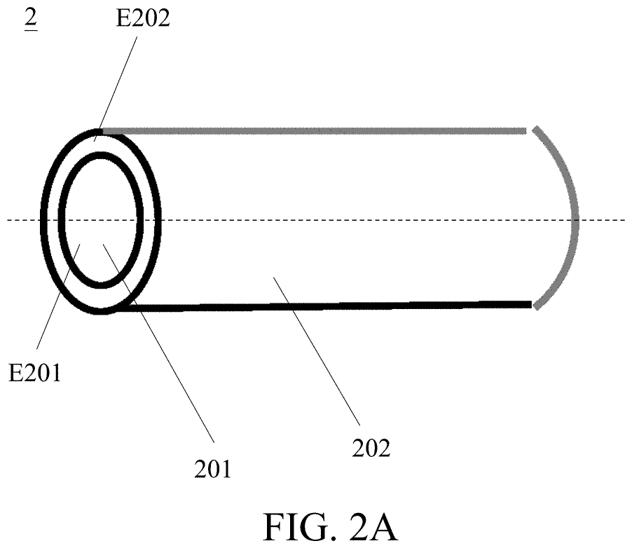

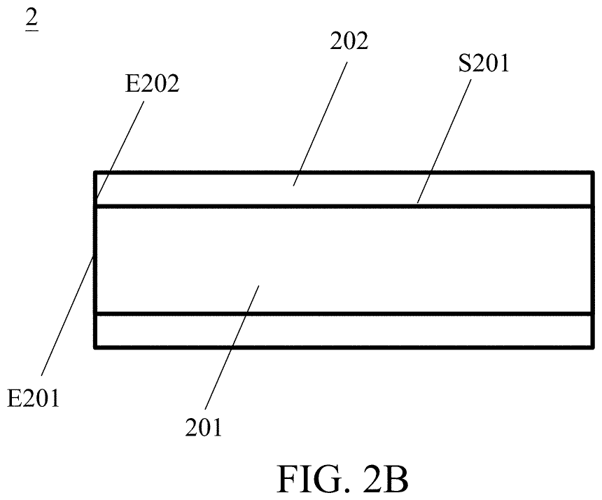

FIGS. 2A and 2B are respectively a schematic diagram and a sectional view of a magnetic pen tip assembly according to a second embodiment of the invention, wherein the dotted line in FIG. 2A is the sectional line. The magnetic pen tip assembly 2 includes a magnetic component 201 and a shielding component 202. The shielding component 202 is a curled part formed by curling a sheet of a magnetically conductive material or a sheet of a magnetically insulating material, unlike the shielding component 102 in FIGS. 1A and 1B which is formed by turning process.

Moreover, similar to the first embodiment, the shielding component 202 in the second embodiment also includes an opening and an accommodating space S201 for accommodating the magnetic component 201, and the magnetic component 201 is disposed in the accommodating space S201 and surrounded and covered by the shielding component 202. A first end E201 of the magnetic component 201 is exposed by the opening of the shielding component 202 and is approximately aligned to a first end E202 of the shielding component 202.

In the first and second embodiments, only the first end of the magnetic component 101, 201 is exposed and the rest of the magnetic component 101, 201 is covered by the shielding component 102, 202, and therefore the magnetic leakage issue is effectively improved so as to solve the blurred-line and early-responding issues caused by conventional magnetic pens. It is to be noted that although the shielding component 102, 202 is formed by turned parts or curled sheets, the invention is not limited by the forming method of the shielding component 201, 202.

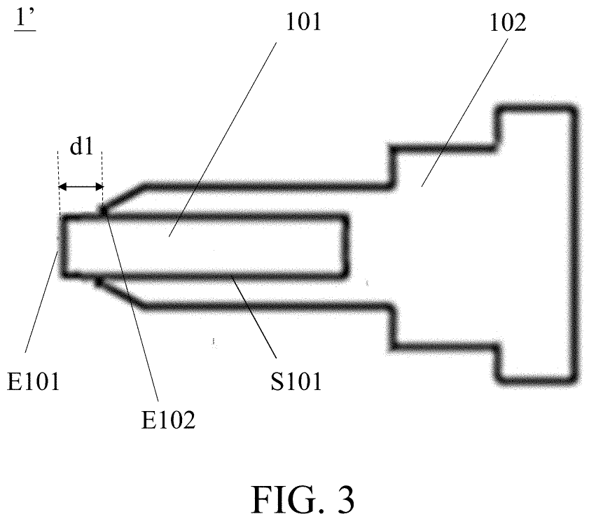

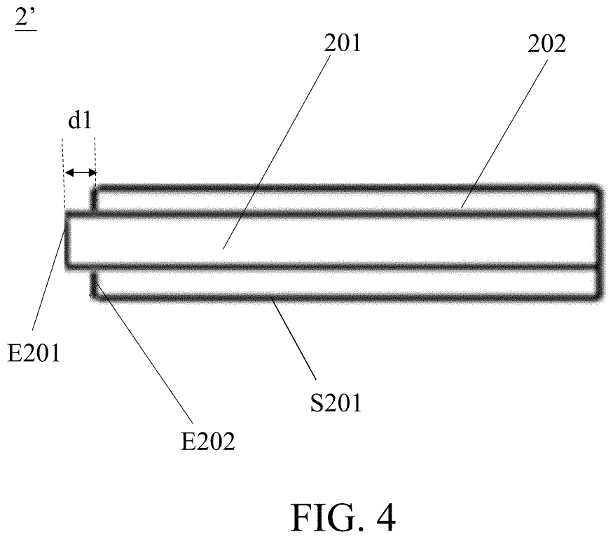

FIGS. 3 and 4 are sectional views of a magnetic pen tip assembly according to a third embodiment and a fourth embodiment of the invention, respectively. The magnetic pen tip assemblies 1′ and 2′ are respectively similar to the magnetic pen tip assemblies 1 and 2, wherein the difference is that in the third and the fourth embodiments, the first end E101, E201 of the magnetic component 101, 201 of the magnetic pen tip assembly 1′, 2′ protrudes outside of the first end E102, E202 of the shielding component 102, 202 of the magnetic pen tip assembly 1′, 2′, wherein a distance d1 between the two first ends E101, E201 and E102, E202 is less than 2 millimeters and preferably less than 0.05 millimeter.

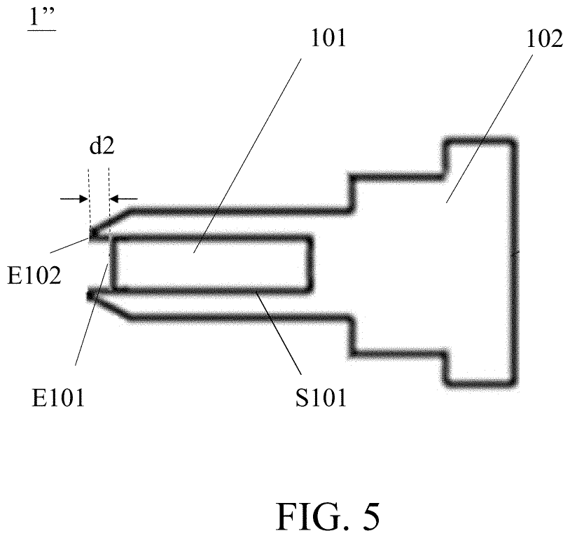

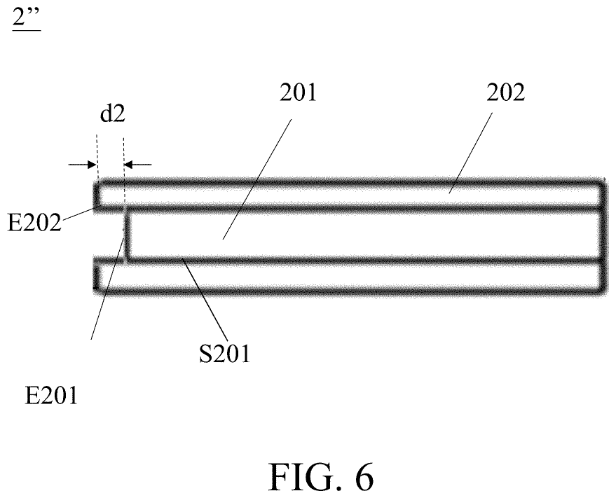

FIGS. 5 and 6 are respectively sectional views of a magnetic pen tip assembly according to a fifth embodiment and a sixth embodiment of the invention. Unlike the first and second embodiments where the two first ends E101, E102 and E201, E202 are aligned, the first end E101, E201 of the magnetic component 101, 201 of the magnetic pen tip assembly 1″, 2″ is positioned inside the accommodating space S101, S102 and a distance d2 away from the first end E201, E202 of the shielding component 102, 202 of the magnetic pen tip assembly 1″, 2″, wherein the distance d2 between the two first ends E101, E102 and E201, E202 is less than 2 millimeters and preferably less than 0.05 millimeter.

The magnetic pen tip assemblies 1, 1′, 1″, 2, 2′, 2″ in the first to sixth embodiments are substantially magnetic pen tips but the invention is not limited thereby. The magnetic pen tip assemblies 1, 1′, 1″, 2, 2′, 2″ can be further processed to become, or implemented in, magnetic pens or magnetic pen refills.

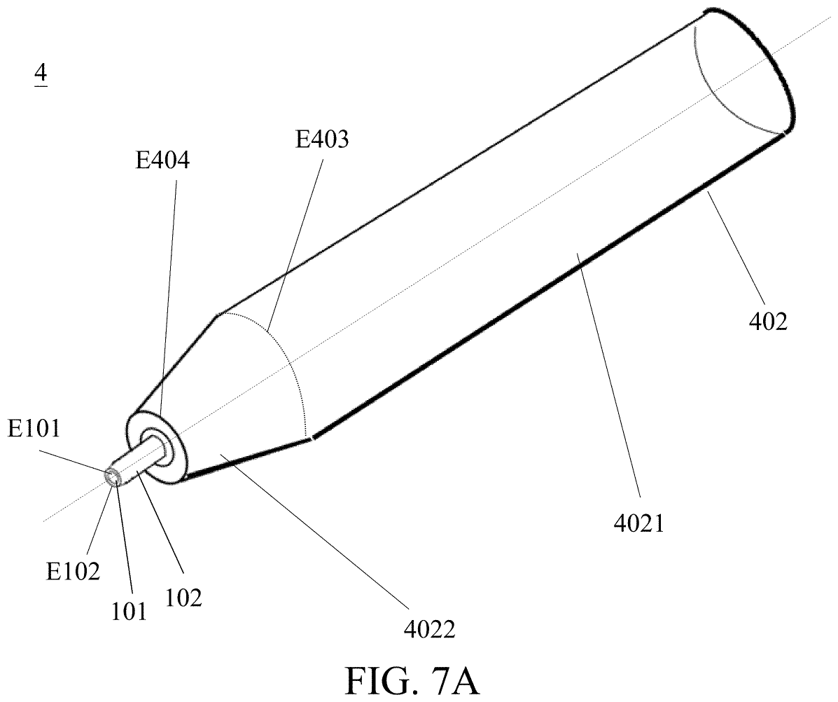

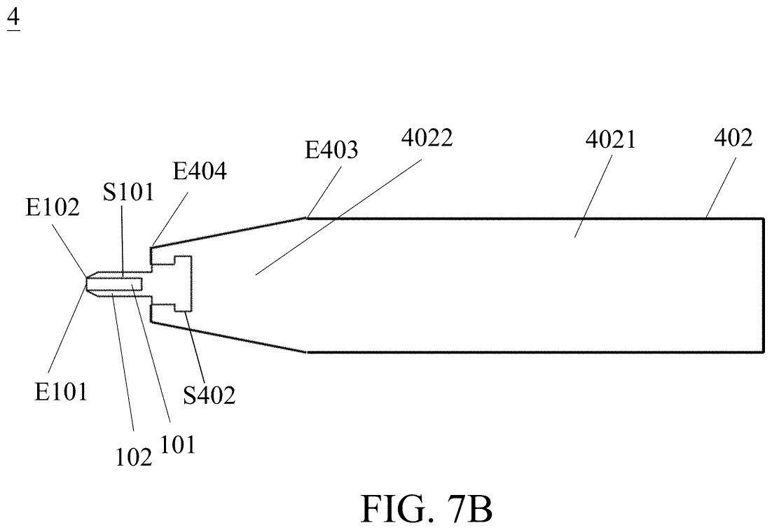

FIGS. 7A and 7B are respectively a schematic diagram and a sectional view of a magnetic pen tip assembly according to a seventh embodiment of the invention, wherein the dotted line in FIG. 7A is the sectional line. The magnetic pen tip assembly 4 of the seventh embodiment is an implementation of the magnetic pen tip assembly 1 of the first embodiment and serves as a magnetic pen for a magnetic drawing board or as a stylus pen for a capacitance touch panel.

In the seventh embodiment, the magnetic pen tip assembly further includes a barrel component 402. The barrel component includes a tube portion 4021 and a tapered portion 4022, wherein the tapered portion 4022 includes a first end E402 and a second end E403 opposite the first end E402 and is tapered from its first end E402 to its second end E403. The tube portion 4021 is connected to the first end E402 of the tapered portion 4022. In this embodiment, the tapered portion 4022 includes a space S402 for accommodating the shielding component 102, such that the shielding component 102 is inserted or engaged to connect to the barrel component 402 and the first end E101 of the magnetic component 101 is exposed by an opening of the barrel component 402.

However, the connecting method between the barrel component 402 and the shielding component 102 of the invention is not limited thereby. In other embodiments, the shielding component 102 can be bonded directly to the tapered portion 4022 of the barrel component 402 and the barrel component 402 does not have the space S402. In addition, the invention is not limited by the embodiments of the aforementioned barrel component 402. For example, the barrel component 402 can include only the tube portion 4021 and the shielding component 102 is connected to the tube portion 4021.

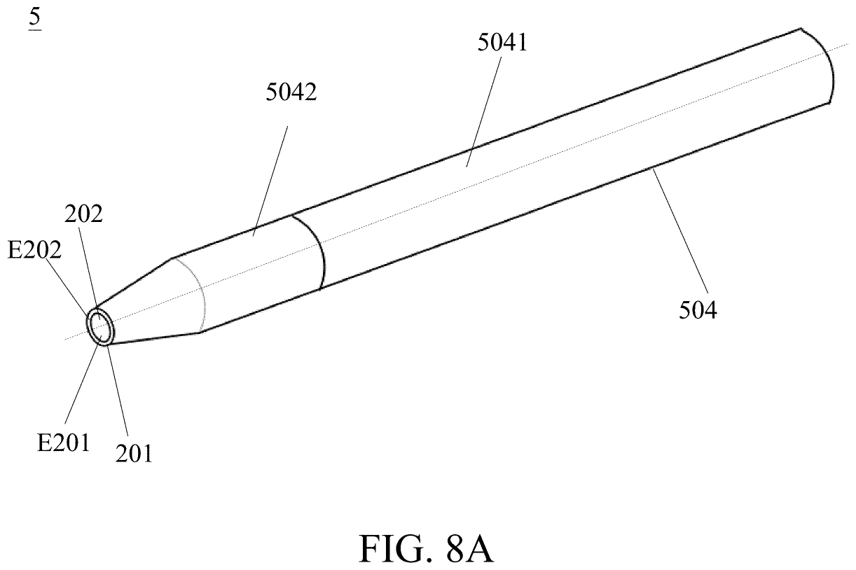

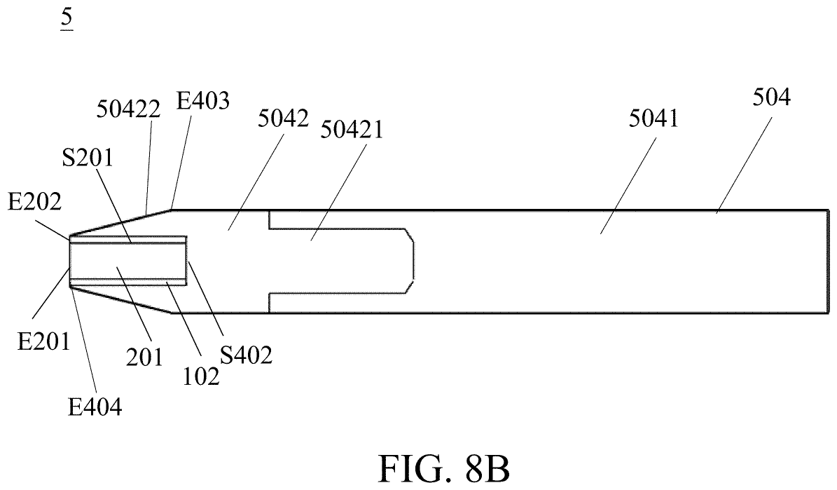

FIGS. 8A and 8B are respectively a schematic diagram and a sectional view of a magnetic pen tip assembly according to an eighth embodiment of the invention, wherein the dotted line in FIG. 8A is the sectional line. The magnetic pen tip assembly 5 of the eighth embodiment is an implementation of the magnetic pen tip assembly 2 of the second embodiment and is to be used as a magnetic pen refill of a magnetic pen for a magnetic drawing board or of a stylus pen for a capacitance touch panel.

The magnetic pen tip assembly 5 includes a refill body 502 with a first component 5021 and a second component 5022, wherein the second component 5022 includes an opening and an accommodating space S502 for accommodating the first component 5021. The first component 5021 includes a tube portion P501 and a tapered portion P502 and the tapered portion P502 includes a first end E502 and a second end E503 opposite the first end E502, wherein the tapered portion P502 is tapered from its first end E502 to its second end E503. The tube portion P501 is connected to the first end E502 of the tapered portion P502. Moreover, the tapered portion P502 of the first component 5021 includes an opening at its second end E503, which in turn forms an accommodating space S503 to accommodate the shielding component 202. Thus, the shielding component 202 is inserted in or engaged to connect to the refill body 502, such that the first end E201 of the magnetic component 201 is exposed by the opening of the refill body 502.

It is to be noted that the connecting method between the refill body 502 and the shielding component 202 of the invention is not limited thereby. In other embodiments, the shielding component 502 can be bonded directly to the tapered portion P502 of the first component 5021 of the refill body 502 and the refill body 502 does not have the opening and the aforementioned space S503. In addition, the invention is not limited by the embodiments of the aforementioned refill body 502. For example, the first component 5021 of the refill body 502 can have just the tube portion P501 and the shielding component 202 is connected to the tube portion P501.

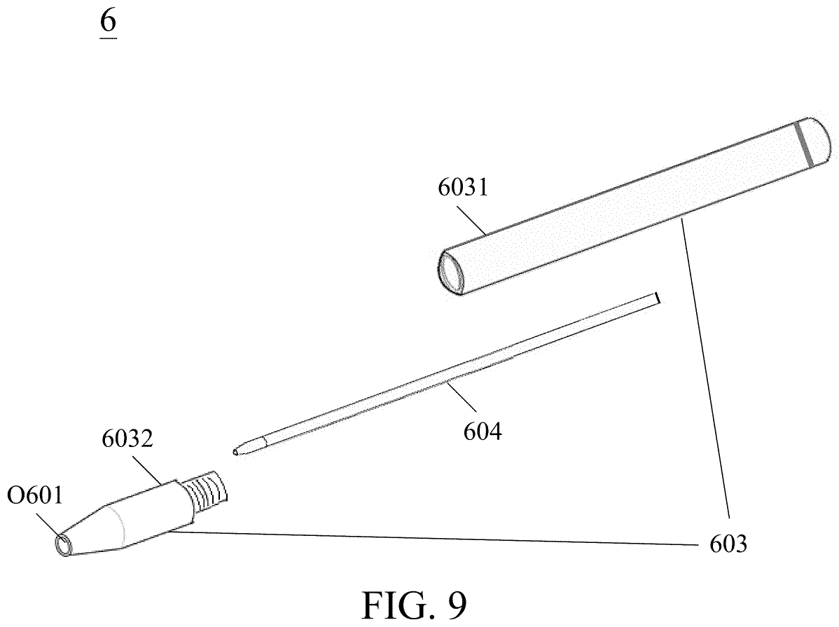

FIG. 9 is an exploded view of a magnetic pen tip assembly according to a ninth embodiment of the invention. The magnetic pen tip assembly 6 of the ninth embodiment is a further implementation of the magnetic pen tip assembly 5 of the eighth embodiment and is utilized as a magnetic pen for a magnetic drawing board or as a stylus pen for a capacitance touch panel. The magnetic pen tip assembly 6 includes a magnetic pen refill 601, which is the magnetic pen tip assembly 5 of the eighth embodiment, and a barrel component 602. The barrel component includes a first component 6021 and a second component 6022, wherein the first component 6021 has an opening O601 and another opening O602 opposite the opening O601, and the second component 6022 has an opening O603.

Each of the first component 6021 and the second component 6022 of the barrel component 602 has an accommodating space for accommodating the magnetic pen refill 601. The other opening O602 of the first component 6021 corresponds to the opening O603 of the second component 6022 such that the first component 6021 is detachably connected to the second component 6022, wherein the detachable connection can be achieved via screw threads. The opening O601 of the first component 6021 of the barrel component 602 corresponds to the first end E201 of the magnetic component of the magnetic pen refill 601.

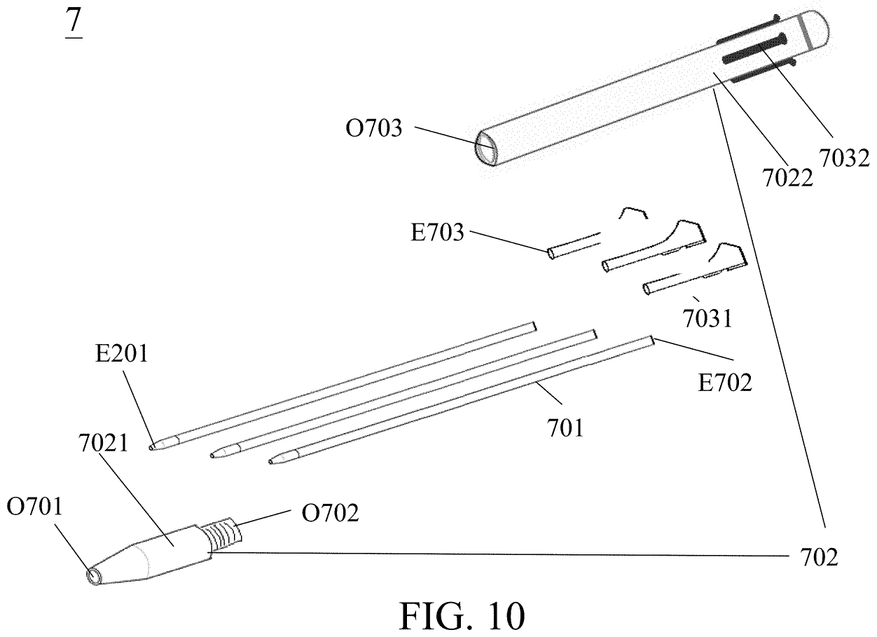

FIG. 10 is an exploded view of a magnetic pen tip assembly according to a tenth embodiment of the invention. The magnetic pen tip assembly 7 of the tenth embodiment is another further implementation of the magnetic pen tip assembly 5 of the eighth embodiment and serves as a magnetic pen for a magnetic drawing board or as a stylus pen for a capacitance touch panel. The magnetic pen tip assembly 7 includes a plurality of magnetic pen tip assemblies 5, and when utilized as the magnetic pen, the magnetic components of the magnetic pen tip assemblies 5 have different magnetic forces to correspondingly draw lines with different thicknesses on the magnetic drawing board.

The magnetic pen tip assembly 7 includes a plurality of magnetic pen refills, which are the plurality of magnetic pen tip assemblies 5 of the eighth embodiment, a plurality of refill switch components 7031, and a barrel component 702. The barrel component 702 includes a first component 7021 and a second component 7022, wherein the first component 7021 has an opening O701 and another opening O702 opposite the opening O701. The second component 7022 includes an opening O703 and the magnetic pen tip assembly 7 further includes a plurality of switch control components 7032 disposed on the second component 7022.

Both of the first component 7021 and the second component 7022 of the barrel component 702 have accommodating space for accommodating the plurality of magnetic pen refills 701 and the plurality of refill switch components 7031. Each magnetic pen refill 701 is connected to one of the refill switch component 7031 by bonding or insertion/engagement, wherein the connection is made between a second end E702 of the magnetic pen refill 701 and a third end E703 of the refill switch component 7031. The other opening O702 of the first component corresponds to the opening O703 of the second component 7022 and the first component 7021 is detachably connected to the second component 7022 by, for example, screw threads. The opening O701 of the first component 7021 of the barrel component 702 corresponds to the plurality of first ends E201 of the plurality of magnetic components of the plurality of magnetic pen refills 701.

In this embodiment, user is able to switch between the magnetic pen refills 701 through operating the switch control components 7032 on the second component 7022 of the barrel component 702. Each of the plurality of magnetic pen refills 701 includes a magnetic component with a magnetic force that differs from other magnetic components, thereby forming a magnetic pen having pen tip selections for drawing lines with different thicknesses on the magnetic drawing board. Moreover, the magnetic pen tip assembly 7 can further includes at least one ink refill disposed in the barrel component 702 so as to act as a multifunctional pen for writing on a magnetic drawing board and on paper.

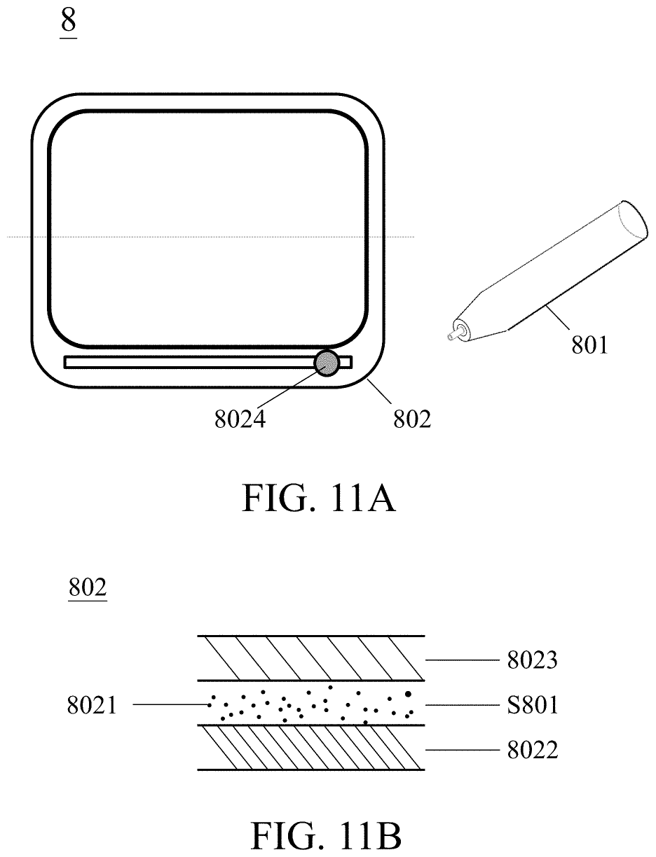

FIGS. 11A and 11B are respectively a schematic diagram and a sectional view of a magnetic drawing board system according to an eleventh embodiment of the invention, wherein the dotted line in the FIG. 11A is the sectional line. The magnetic pen tip assembly of the invention is utilized in the magnetic drawing system 8. The magnetic drawing system 8 includes a magnetic pen 801 and a magnetic drawing board 802, wherein the magnetic pen 801 is the magnetic pen tip assembly 4 of the seventh embodiment but the invention is not limited thereby.

The magnetic drawing board system 802 includes a magnetic substance 8021, a substrate 8022, and a cover 8023. A common configuration of the magnetic drawing board 802 is a layer of substrate 8022 and a layer of translucent or semi-translucent cover 8023 stacked together, wherein an intermediate layer S801 is formed between the stacked substrate 8022 and cover 8023. The magnetic substance 8021 is placed in the intermediate layer 8021 and is often colored magnetic particles. When the magnetic pen 801 touches the cover 8023, the magnetic substance 8021 is drawn to the surface of the cover 8023 in response to the magnetic force of the magnetic pen 801 and become visible on the transparent/semitransparent cover 8023; a pattern is then drawn base the movement of the magnetic pen 801. If the user wishes to erase the pattern on the cover 8023, a slider 8024 of the magnetic drawing board 802 is used to move a long magnetic bar across the magnetic drawing board 802, which in turn draws the magnetic substance 8021 downwards and thus removing the appearance on the cover 8023. It is to be noted that the invention is not limited by the embodiment of the magnetic drawing board 801.

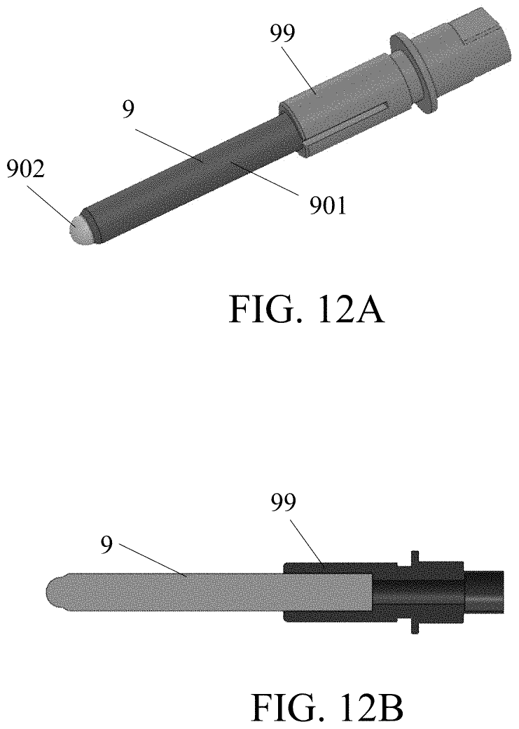

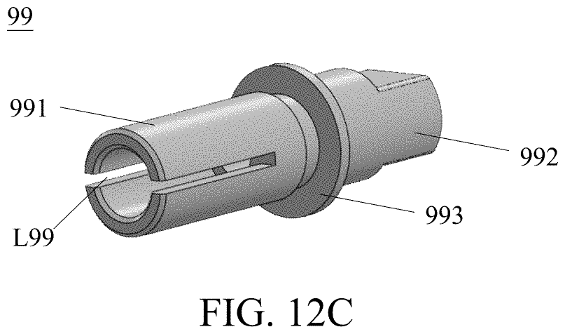

FIGS. 12A to 12C are respectively a schematic diagram and a sectional view of a changeable magnetic pen tip assembly and a schematic diagram of a holder according to a twelfth embodiment of the invention. The changeable magnetic pen tip assembly consists of a magnetic pen tip assembly 9 and a holder 99, and in this embodiment, the magnetic pen tip assembly 9 includes a magnetic component 901 and a shielding component 902. The magnetic component 901 is dispose in an accommodating space of the shielding component 902 and is surrounded and covered by the shielding component 902. A first end of the magnetic component 901 is exposed by an opening of the shielding component 902. A distance between the first end of the magnetic component 901 and a first end of the shielding component 902 is less than 2 millimeters. The magnetic pen tip assembly 9 is disposed in an accommodating space of the holder 99, wherein user can change or replace the magnetic pen tip assembly 9 by taking the magnetic pen tip assembly 9 out of the holder 99 and inserting a new magnetic pen tip assembly 9 into the holder 99.

The holder 99 includes a holding part 991, a fastening part 992, and a positioning part 993 connected between the holding part 991 and the connecting part 992. The holding part 991 includes a slit L99 and an accommodating space. In this embodiment, the magnetic pen tip assembly 9 is inserted into the accommodating space of the holding part 991 and through the design of the slit L99, and the magnetic pen tip assembly 9 is able to be detachably disposed in the accommodating space of the holding part 991. The fastening part 992 is engaged to a barrel body and the positioning part 993 acts as a stopper to position the holder 99 relative to the barrel body.

In conclusion, the embodiments of the invention provides a magnetic pen tip assembly utilizing a shielding component with an opening and an accommodating space to cover around a magnetic component, so that only a first end of the magnetic component is exposed to reduce the magnetic leakage of the magnetic component. The aforementioned magnetic pen tip assembly is used as a magnetic pen in a tablet system, wherein the tablet system includes a tablet that can be a magnetic drawing board or a capacitance touch panel. Therefore, when user draws on a magnetic drawing board with the magnetic pen of the invention, issues like blurred lines and early-responding caused by magnetic particles in the magnetic drawing board being drawn due to magnetic leakage of the magnetic component can be avoided. Furthermore, the magnetic pen tip assembly of the invention acting as a magnetic pen can also be used as a stylus pen for a capacitance touch panel. In addition, the manufacturing of the magnetic pen tip assembly according to the embodiments of the invention is easy and low in cost, and thus the invention has market advantage and can be effectively used in the industry.

The above disclosure is only the preferred embodiment of the present invention, and not used for limiting the scope of the present invention. All equivalent variations and modifications on the basis of shapes, structures, features and spirits described in claims of the present invention should be included in the claims of the present invention.

What is claimed is:

1. A magnetic pen tip assembly comprising:
a shielding component comprising a first end, an opening and an accommodating space; and
a magnetic component disposed in the accommodating space and comprising a first end;
wherein the magnetic component is surrounded and covered by the shielding component, the first end of the magnetic component is exposed by the opening of the shielding component, and a distance between the first end of the magnetic component and the first end of the shielding component is less than 2 millimeters.

2. The magnetic pen tip assembly of claim 1, wherein the distance is less than 0.05 millimeter.

3. The magnetic pen tip assembly of claim 1, wherein the magnetic component is a permanent magnet, a temporary magnet, an electromagnet, or an electric permanent magnet.

4. The magnetic pen tip assembly of claim 1, wherein the shielding component is made of a magnetically conductive metal or a plastic material.

5. The magnetic pen tip assembly of claim 1, wherein the shielding component is a turned part formed by turning processing a magnetically conductive material or a magnetically insulating material, or is a curled part formed by curling a sheet of a magnetically conductive material or a magnetically insulating material.

6. The magnetic pen tip assembly of claim 1, wherein the magnetic pen tip assembly is a magnetic pen for a magnetic drawing board or a stylus pen for a capacitance touch panel, and the magnetic pen tip assembly further comprises:
a barrel component connected to or accommodating the shielding component.

7. The magnetic pen tip assembly of claim 6, wherein the barrel component comprises a tube portion with a first end and a tapered portion with a first end and a second end opposite the first end, the first end of the tube portion is connected to the first end of the tapered portion, the tapered portion is tapered from its first end to its second end, and the shielding component is bonded to the second end of the tapered portion or the tapered portion comprises a space in which the shielding component is inserted or engaged.

8. The magnetic pen tip assembly of claim 1, wherein the magnetic pen tip assembly is a magnetic pen refill of a magnetic pen for a magnetic drawing board or of a stylus pen for a capacitance touch panel, and the magnetic pen tip assembly further comprises:
a refill body connected to or accommodating the shielding component;
wherein a barrel component of the magnetic pen accommodates the magnetic pen tip assembly and an opening of the barrel component corresponds to the first end of the magnetic component.

9. The magnetic pen tip assembly of claim 8, wherein the refill body comprises a first component and a second component, the second component is connected to or accommodates the first component, the first component comprises a tube portion with a first end and a tapered portion with a first end and a second end opposite the first end, the first end of the tube portion is connected to the first end of the tapered portion, the tapered portion is tapered from its first end to its second end, and the shielding component is bonded to the second end of the tapered portion or the tapered portion comprises a space in which the shielding component is inserted or engaged.

10. The magnetic pen tip assembly of claim 1, wherein the magnetic pen tip assembly is a magnetic pen for a magnetic drawing board or a stylus pen for a capacitance touch panel, and the magnetic pen tip assembly further comprises:
a refill body connected to or accommodating the shielding component, wherein the refill body, the shielding component, and the magnetic component form a magnetic pen refill; and
a barrel component for accommodating the magnetic pen refill and comprises an opening that corresponds to the first end of the magnetic component.

11. The magnetic pen tip assembly of claim 10, wherein the barrel component comprises a first component and a second component, and the opening of the barrel component is on the first component and the first component is detachably connected to the second component.

12. The magnetic pen tip assembly of claim 10, further comprising:
a plurality of refill switch components disposed in the barrel component;
at least one other magnetic pen refill; and
a plurality of switch control components disposed on the barrel component;
wherein each of the magnetic pen refills correspondingly connects to one of the refill switch components, and the plurality of switch control components control the refill switch components to switch the magnetic pen refills.

13. The magnetic pen tip assembly of claim 1, wherein the magnetic pen tip assembly is detachably disposed in a holder that is connected to a pen body.

14. A tablet system comprising:
a tablet, wherein the tablet is a magnetic drawing board or a capacitance touch panel; and
a magnetic pen or a stylus pen, comprising:
a shielding component comprising a first end, an opening, and an accommodating space; and
a magnetic component disposed in the accommodating space and comprising a first end, wherein the magnetic component is surrounded and covered by the shielding component, the first end of the magnetic component is exposed by the opening of the shielding component, and a distance between the first end of the shielding component and the first end of the magnetic component is less than 2 millimeters.

15. The tablet system of claim 14, wherein the shielding component is a turned part formed by turning processing a magnetically conductive material or a magnetically insulating material, or is a curled part formed by curling a sheet of a magnetically conductive material or a magnetically insulating material.

16. The tablet system of claim 14, wherein the magnetic pen or the stylus pen further comprises:
a barrel component connected to or accommodating the shielding component.

17. The tablet system of claim 14, wherein the magnetic pen or the stylus pen further comprises:
a refill body connected to or accommodating the shielding component, wherein the refill body, the shielding component, and the magnetic component form a magnetic pen refill; and
a barrel component for accommodating the magnetic pen refill and comprises an opening to which the first end of the magnetic component corresponds.

18. The tablet system of claim 17, wherein the magnetic pen or the stylus pen further comprises:
a plurality of refill switch components disposed in the barrel component;
at least one other magnetic pen refill; and
a plurality of switch control components disposed in the barrel component;
wherein each of the magnetic pen refills correspondingly connects to one of the refill switch components, and the plurality of switch control components control the refill switch components to switch the magnetic pen refills.

19. The tablet system of claim 14, wherein the distance between the first end of the magnetic component and the first end of the shielding component is less than 0.05 millimeter.

20. The tablet system of claim 14, wherein the magnetic component is a permanent magnet, a temporary magnet, an electromagnet, or an electric permanent magnet, and the shielding component is made of a magnetically conductive metal or a plastic material.
